(19) United States
(12) Patent Application Publication
(10) Pub. No.: US 2026/0253764 A1
(43) Pub. Date: Aug. 27, 2026

(54) METHOD AND APPARATUS FOR RECOVERING COPPER OR COPPER ALLOY FROM ENAMELED WIRE

(71) Applicant: Proterial, Ltd., Tokyo (JP)

(72) Inventors: Ko KERUMA, Tokyo (JP); Tetsuro SATO, Tokyo (JP)

(21) Appl. No.: 19/529,878

(22) Filed: Feb. 4, 2026

(30) Foreign Application Priority Data
Feb. 21, 2025 (JP) 2025-027320

(51) Int. Cl. H01B 15/00; H01B 3/08

(52) U.S. Cl. CPC H01B 15/006; H01B 3/081

(57) ABSTRACT

The present invention provides a method and an apparatus for recovering copper or copper alloy from enameled wire, which can decrease environmental load and recover high-purity copper with low processing costs. A method for recovering copper or copper alloy from enameled wire, by removing an insulator 22 from an enameled wire 2 including the insulator 22 around a conductor 21 made of copper or copper alloy includes a separating step of separating the insulator 22 from the conductor 21, by performing a rolling processing on the enameled wire 2, and a removing step of removing the insulator 22 separated from the conductor 21 in the separating step, wherein, in the separating step, the rolling processing is performed to have an elongation A expressed in a following formula be 15.1% or more: A={(A1−A2)/A2}×100, where A1 is a cross-sectional area of the conductor before the rolling processing and A2 is a cross-sectional area of the conductor after the rolling processing.

### CROSS-REFERENCE TO RELATED APPLICATIONS

The present application is based on Japanese patent application No. 2025-027320 filed on Feb. 21, 2025, the entire contents of which are incorporated herein by reference.

### TECHNICAL FIELD

The present invention relates to a method and an apparatus for recovering copper or copper alloy from enameled wire.

An enameled wire in which an insulator is formed by coating and drying enamel varnish around a conductor has been known. For the enameled wire, it is known that removal of the insulator from the conductor and recovery of copper are difficult in disposing of the enameled wire because of high adhesion between the conductor and the insulator.

### BACKGROUND OF THE INVENTION

Patent Literature 1 discloses a method for removing an insulator from an enameled wire by heating and carbonizing the insulator of the enameled wire, and then applying mechanical force to the insulator. Patent Literature 2 discloses a method for removing an insulator from an enameled wire by immersing the enameled wire in an alkaline solution to hydrolyze the insulator.

### CITATION LIST

### Patent Literature

Patent Literature 1: JP2011-174175A

Patent Literature 2: JPH10-025523A

### SUMMARY OF THE INVENTION

### Problems to be Solved by the Invention

However, in the method described in Patent Literature 1, there is a problem in that the processing cost becomes high because, in order to carbonize the insulator, it is necessary to heat the insulator to a high temperature of 500° C. or more, so that an enormous amount of thermal energy is required. Further, it is probable that the purity of the copper that can be recovered decreases because, during heating, the conductor may be oxidized, or the carbonized material and the conductor may become integrated with each other.

In the method described in Patent Literature 2, there is a problem in that the environmental load becomes large and the processing cost becomes high because a highly concentrated alkaline solution is required, so that the cost of the chemical agent is incurred, and wastewater treatment is required. Further, the processing cost becomes even higher because heating is required in order to hydrolyze the insulator.

Therefore, an object of the present invention is to provide a method and apparatus for recovering copper or copper alloy from enameled wire, which can decrease environmental load and recover high-purity copper with low processing costs.

To solve the above problem, the present invention provides a method for recovering copper or copper alloy from enameled wire, by removing an insulator from an enameled wire including the insulator around a conductor made of copper or copper alloy, comprising: a separating step of separating the insulator from the conductor, by performing a rolling processing on the enameled wire; and a removing step of removing the insulator separated from the conductor in the separating step, wherein, in the separating step, the rolling processing is performed to have an elongation A expressed in a following formula be 15.1% or more: A={(A1−A2)/A2}×100, where A1 is a cross-sectional area of the conductor before the rolling processing and A2 is a cross-sectional area of the conductor after the rolling processing.

### Means for Solving the Problem

To solve the above issue, the present invention provides an apparatus for recovering copper or copper alloy from enameled wire, by removing an insulator from an enameled wire including the insulator around a conductor made of copper or copper alloy, comprising: a separating device that separates the insulator from the conductor, by performing a rolling processing on the enameled wire; and a removing device that removes the insulator separated from the conductor by the separating device, wherein the separating device performs the rolling processing to have an elongation A expressed in a following formula be 15.1% or more: A={(A1−A2)/A2}×100, where A1 is a cross-sectional area of the conductor before the rolling processing and A2 is a cross-sectional area of the conductor after the rolling processing.

### Advantageous Effects of the Invention

According to the present invention, it is possible to provide a method and apparatus for recovering copper or copper alloy from enameled wire, which can decrease environmental load and recover high-purity copper with low processing costs.

### BRIEF DESCRIPTION OF DRAWINGS

FIG. 1 is a schematic drawing showing an apparatus for recovering copper or copper alloy from enameled wire, which is used for a method for recovering copper or copper alloy from enameled wire, according to an embodiment of the present invention.

FIG. 2 is an explanatory diagram for explaining a separating step.

FIG. 3 is a diagram showing an example of a removing device.

FIG. 4 is a flow chart showing the method for recovering copper or copper alloy from enameled wire, according to the embodiment of the present application.

FIG. 5A is a graph chart showing an evaluation of elongation and dimensional change rate in thickness direction, and separation.

FIG. 5B is a graph chart showing an evaluation of separation between elongation and dimensional change rate in thickness direction.

### DETAILED DESCRIPTION OF THE INVENTION

### Embodiment

The embodiments of the present invention will be described in conjunction with the accompanying drawings.

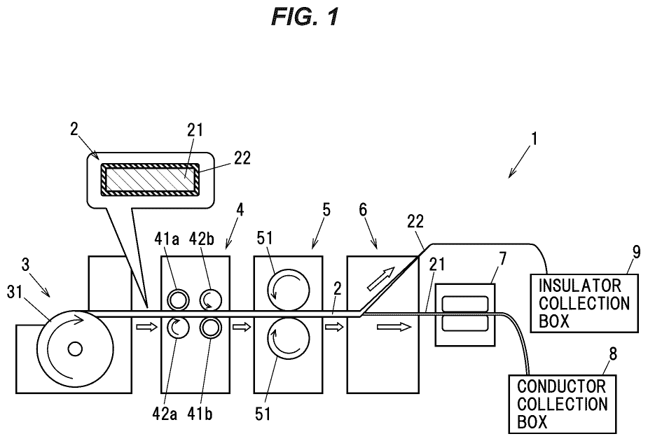

FIG. 1 is a schematic drawing showing an apparatus 1 for recovering copper or copper alloy from enameled wire (hereinafter, simply referred to as the recovery apparatus 1) used for a method for recovering copper or copper alloy from enameled wire, according to an embodiment of the present invention. As shown in FIG. 1, the recovery apparatus 1 is an apparatus for recovering copper or copper alloy constituting a conductor 21 by removing an insulator 22 from the conductor 21 of an enameled wire 2.

The enameled wire 2 is an electric wire used for, e.g., a motor for vehicles, a transformer, or an induction heating coil. The enameled wire 2 may be a round wire with a circular cross-section, or a flat wire with a rectangular cross-section. In addition, the enameled wire 2 is not limited to the round wire and the flat wire. For example, the cross-section may be ellipse shaped or triangle shape, the cross-section is not limited thereto. The enameled wire 2 includes the conductor 21 made of copper or copper alloy, and the insulator 22 formed by coating and heating enamel varnish around the conductor 21. The insulator 22 is made of, e.g., polyimide, polyamide-imide, polyester, polyurethane, or polyimide ester.

It is known that the insulator 22 has high adhesion to the conductor 21 in the enameled wire 2. Thus, it is not easy to remove the insulator 22 from the conductor 21 and recover the conductor (i.e., recovering copper or copper alloy constituting the conductor 21) when disposing the enameled wire 2. The recovery apparatus 1 according to the embodiment can easily remove the insulator 22 from the enameled wire 2 having high adhesion between the conductor 21 and the insulator 22, and achieve easy recovery of copper or copper alloy constituting the conductor 21.

As shown in FIG. 1, the recovery apparatus 1 mainly comprises a feeding device (pay-off device) 3, a slitting device 4, a separating device 5, a removing device 6, and a take-up device 7. Hereinafter, each device will be described in detail.

### (Feeding Device 3)

The feeding device 3 is a device for performing a feeding step to continuously feed the enameled wire 2 wound on a bobbin 31. The feeding device 3 is configured to feed the enameled wire 2 at a constant speed, by pulling the conductor 21 by the separating device 5 and the take-up device 7 described below at a constant speed.

### (Slitting Device 4)

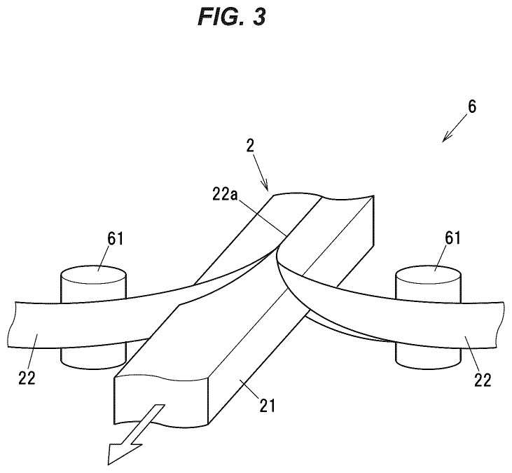

The slitting device 4 is a device for performing a slitting step to make a slit 22a (see FIG. 3) in the insulator 22 of the enameled wire 2 along a longitudinal direction continuously by using a cutter or laser and so on. The slitting device 4 comprises a first roll cutter 41a and a first guide roll 42a arranged opposite each other, and a second roll cutter 41b and a second guide roll 42b arranged opposite each other. The roll cutters 41a, 41b have blades on outer peripheries thereof and are configured in such a manner that the slit 22a can be made in the insulator 22 along the longitudinal direction of the enameled wire 2 continuously, by drawing the enameled wire 2 with pressing the blades against the insulator 22, while rotating the roll cutters 41a, 41b.

In the present embodiment, the slitting device 4 is configured to respectively make slits 22a on two surfaces against which one pair of rolling rolls 51 are pressed when performing a rolling processing in the separating step described below. When using only one rolling roll 51 in the rolling processing, it is preferable to make the slits 22a at a surface against which the rolling roll 51 is pressed and at an opposite surface, respectively. Accordingly, the insulator 22 can be easily collected, since the insulator 22 is divided into two in a direction perpendicular to a rolling direction (i.e., in a width direction).

Specifically, the slitting device 4 performs a first slitting step of making the slit 22a in the insulator 22 (on an upper surface in the example shown in FIG. 1) by passing the enameled wire 2 between the first roll cutter 41a and the first guide roll 42a. Then, the slitting device 4 performs a second slitting step of making the slit 22a in the insulator 22 at the opposite position to the slit 22a provided in the first slitting step (on a lower surface in the example shown in FIG. 1) by passing the enameled wire 2 between the second roll cutter 41b and the second guide roll 42b after the first slitting step.

In the meantime, the slitting device 4 may be configured to collectively make the slits 22a at two surfaces opposed to each other of the enameled wire 2 by arranging one pair of roll cutters 41a, 41b opposite each other and passing the enameled wire 2 between them. However, in such a case, defects such as tilting posture of the enameled wire 2 may occur, even when a slight misalignment between the pair of roll cutters 41a, 41b opposite each other occurs. Thus, it is more preferable to arrange the roll cutters 41a, 41b and the guide rolls 42a, 42b opposite each other to make the slits 22a stably.

In the present embodiment, the slitting step is performed before the separating step. Accordingly, the insulator 22 can be easily divided along the slits 22a in the rolling processing of the separating step. Thus, the insulator 22 can be easily removed in a removing step described below.

### (Separating Device 5)

The separating device 5 is a device for performing the separating step of separating the insulator 22 from the conductor 21 by performing the rolling processing on the enameled wire 2. In the present embodiment, the enameled wire 2 is rolled to separate the insulator 22 from the conductor 21, by passing the enameled wire 2 between the pair of rolling rolls 51.

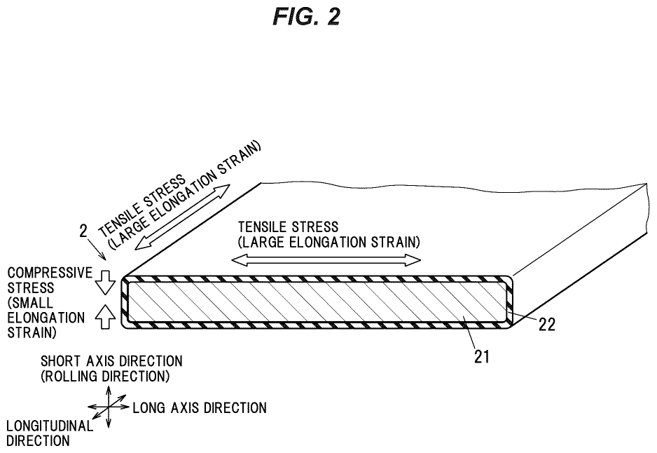

In more detail, as shown in FIG. 2, by performing the rolling processing on the enameled wire 2, the enameled wire 2 is deformed to stretch and extend in a direction (the longitudinal direction and a long axis direction of the enameled wire 2 in an illustrated example) perpendicular to the rolling direction (a short axis direction of the enameled wire 2 in the illustrated example) so that a compressive stress acts in the rolling direction and a tensile stress acts in the direction (the longitudinal direction and a long axis direction of the enameled wire 2 in an illustrated example) perpendicular to the rolling direction. Thus, the enameled wire 2 is stretched in the longitudinal direction and the long axial direction of the enameled wire 2, so that a shear stress is generated at an interface between the conductor 21 and the insulator 22 because of the difference in stretchability between the conductor 21 and the insulator 22, thereby causing a partial separation between the conductor 21 and the insulator 22.

As a result of the research, the inventors found that the insulator 22 can be easily separated by increasing the elongation of the enameled wire 2 in the longitudinal direction. Specifically, the separating device 5 is preferably configured in such a manner that the rolling processing is performed to have an elongation A expressed in the following formula be 15.1% or more:

$$A = \{ ( A 1 - A 2 ) / A 2 \} \times 100 ,$$

where A1 is a cross-sectional area of the conductor 21 before the rolling processing and A2 is a cross-sectional area of the conductor 21 after the rolling processing. Herein, A is referred to as “elongation A”, and A correlates with elongation during rolling. The elongation A can be adjusted by a load applied by the pair of rolling rolls 51 or an outer diameter of the rolling roll 51 to be used. For example, the elongation A of the enameled wire 2 in the longitudinal direction can be increased by decreasing the outer diameter of the rolling roll 51, thereby decreasing a contact area between the rolling rolls 51 and the enameled wire 2. In addition, the elongation A can be adjusted by the adjustment of a gap between the rolling rolls 51 or the adjustment of frictional coefficient between the rolling rolls 51 and the enameled wire 2 (by changing a surface roughness of the rolling roll 51, using lubricating oil, and the like). For example, the elongation A can be increased by reducing the frictional coefficient between the rolling rolls 51 and the enameled wire 2.

Further, as the elongation A increases, the insulator 22 is easily separated. As a result of the inventors' research, it was confirmed that the insulator 22 can be separated by performing only the rolling processing, with the elongation A being 87.5% or more, thereby making the removal step easier. Therefore, the separating device 5 is preferably configured to perform the rolling processing in such a manner that the elongation A is 87.5% or more.

### (Removing Device 6)

The removing device 6 is a device for performing a removing step to strip and remove the separated insulator 22 from the conductor 21. In the present embodiment, as shown in FIG. 3, the removing device 6 is configured to guide the insulator 22 divided into two in right and left along the slits 22a through a guide roll 61 to split into right and left so that the insulator 22 is stripped and removed from the conductor 21. The conductor 21 is collected in a conductor collection box 8 through the take-up device 7. The insulator 22 stripped from the conductor 21 is collected in the insulator collection box 9.

The removing device 6 may be configured to strip the insulator 22 from the conductor 21 by using a wire brush or scraper. In addition, the removing device 6 may be configured to remove the insulator 22 from the conductor 21, by high-pressure water jet treatment, compressed air injection treatment, or blast treatment (sand blast, dry ice blast, and the like).

### (Take-Up Device 7)

The take-up device 7 is a device for taking up the conductor 21 at a constant speed. The conductor 21 taken up by the take-up device 7 is collected in the conductor collection box 8. The conductor 21 collected in the conductor collection box 8 is recovered and reused.

### (Method for Recovering Copper or Copper Alloy of Enameled Wire)

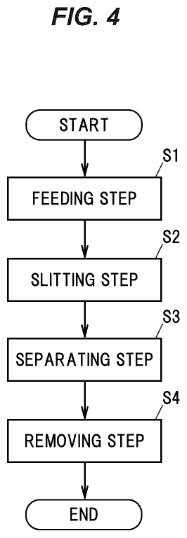

FIG. 4 is a flow chart showing the method for recovering copper or copper alloy from enameled wire according to the embodiment. As shown in FIG. 4, in the method for recovering copper or copper alloy from enameled wire according to the embodiment, at first, the feeding step is performed in Step S1. In the feeding step, the enameled wire 2 wound on the bobbin 31 is fed continuously.

Next, the slitting step is performed in Step S2. In the slitting step, the slit 22a is made in the insulator 22 of the enameled wire 2 along the longitudinal direction continuously, prior to the separating step. In the present embodiment, the first slitting step of making the slit 22a in the insulator 22 by passing the enameled wire 2 between the first roll cutter 41a and the first guide roll 42a, and the second slitting step of making the slit 22a in the insulator 22 at the opposite position to the slit 22a provided in the first slitting step, by passing the enameled wire 2 between the second roll cutter 41b and the second guide roll 42b, after the first slitting step sequentially.

Next, the separating step is performed in Step S3. In the separating step, the rolling processing is performed on the enameled wire 2 to separate the insulator 22 from the conductor 21. In this step, the rolling processing is performed to have the elongation A expressed in the following formula be 15.1% or more (more preferably 87.5% or more):

$$A = \{ ( A 1 - A 2 ) / A 2 \} \times 100 ,$$

where A1 is the cross-sectional area of the conductor 21 before the rolling processing and A2 is the cross-sectional area of the conductor 21 after the rolling processing. Accordingly, the insulator 22 can be easily separated from the conductor 21.

Next, the removing step is performed in Step S4. In the removing step, the insulator 22 separated from the conductor 21 is stripped and removed. The conductor 21 from which the insulator 22 is removed is collected in the conductor collection box 8 and reused.

### (Evaluation of Separating Step)

The thickness and width of the conductor 21 after the rolling processing were measured after changing the degree of the compression processing, and a dimensional change rate in the width direction (the long axis direction) of the conductor 21, a dimensional change rate in the thickness direction (the short axis direction) of the conductor 21, and the elongation A as described above were calculated. In addition, for the enameled wire 2 after the rolling processing, whether the insulator 22 was separated from the conductor 21 was evaluated.

The dimensional change rate in the width direction can be obtained by the following formula:

$$Dimensional change rate in the width direction ( \% ) = \{ ( W 1 - W 2 ) / W 1 \} \times 100 ,$$

where a width of the conductor 21 before the rolling processing (e.g., a length of a flat wire in the long axis direction) is W1, and a width of the conductor 21 after the rolling processing is W2.

Similarly, the dimensional change rate in the thickness direction can be obtained by the following formula:

$$Dimensional change rate in the thickness direction ( \% ) = \{ ( D 1 - D 2 ) / D 1 \} \times 100 ,$$

where a thickness of the conductor 21 before the rolling processing (e.g., a length of the flat wire in the short axis direction) is D1, and a thickness of the conductor 21 after the rolling processing is D2.

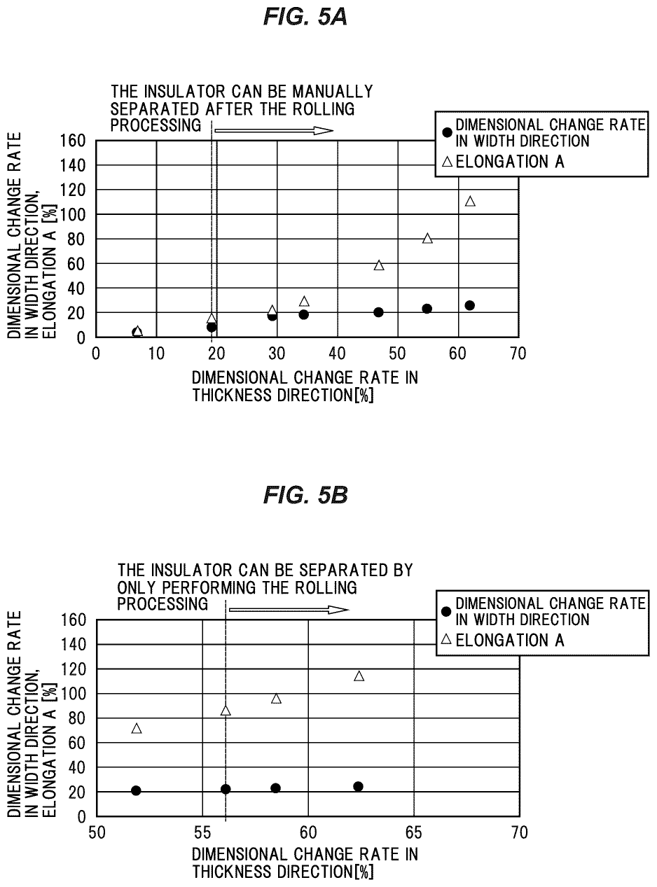

In the evaluation of separation, for the enameled wires 2 after the rolling processing, the case where the insulator 22 could be separated from the conductor 21 manually is evaluated as “Pass” (o), and the case where the insulator 22 could not be separated from the conductor 21 manually is evaluated as “Fail” (x). The summary of results will be shown in Table 1 and FIG. 5A. In addition, the comparative example 1 shows an initial state for which the rolling processing has not yet been performed.

TABLE 1

| | Dimensional Change | | | Evaluation |
|---|---|---|---|---|
| | Rate of Conductor (%) | | Elongation | of |
| | Thickness | Width | A(%) | Separation |
| Comparative | 0.0 | 0.0 | 0.0 | x |
| Example 1 | | | | |
| Comparative | 6.9 | 2.3 | 5.0 | x |
| Example 2 | | | | |
| Example 1 | 19.3 | 7.6 | 15.1 | ∘ |
| Example 2 | 29.3 | 16.3 | 21.7 | ∘ |
| Example 3 | 34.7 | 17.5 | 30.3 | ∘ |
| Example 4 | 46.9 | 18.9 | 58.5 | ∘ |
| Example 5 | 55.0 | 22.4 | 81.5 | ∘ |
| Example 6 | 62.1 | 24.6 | 111.5 | |

As shown in Table 1 and FIG. 5A, in the comparative examples 1, 2 having the elongation A of less than 15.1%, the evaluations of separation were “Fail”. In Examples 1 to 6 having the elongation A of 15.1% or more, the evaluations of separation were “Pass”. It was confirmed that the evaluations of separation were “Pass” when the dimensional change rate in the thickness direction was 19.3% or more and the dimensional change rate in the width direction was 7.6% or more.

Next, a similar study was performed with a stricter evaluation of separation. The case where the insulator 22 was separated from the conductor 21 only by the rolling processing is evaluated as “Pass” (o), and the case where the insulator 22 was not separated from the conductor 21 only by the rolling processing is evaluated as “Fail” (x). The summary of results will be shown in Table 2 and FIG. 5B.

TABLE 2

| | Dimensional Change | | | Evaluation |
|---|---|---|---|---|
| | Rate (%) | | Elongation | of |
| | Thickness | Width | A (%) | Separation |
| Example 7 | 51.9 | 20.2 | 73.0 | x |
| Example 8 | 56.0 | 21.4 | 87.5 | ∘ |
| Example 9 | 58.5 | 22.1 | 97.4 | ∘ |
| Example 10 | 62.5 | 23.4 | 115.9 | ∘ |

As shown in Table 2 and FIG. 5B, when the evaluation of separation was stricter, in Example 7 having the elongation A of less than 87.5%, the evaluation of separation was “Fail”. In Examples 8 to 10 having the elongation A of 87.5% or more, even when the evaluation of separation was stricter, the evaluations of separation were “Pass”. It was confirmed that the evaluations of separation were “Pass” when the dimensional change rate in the thickness direction was 56.0% or more and the dimensional change rate in the width direction was 21.4% or more.

From the above results, it was confirmed that the insulator 22 can be separated from the conductor 21 to the extent that the insulator 22 can be manually separated after the rolling processing to have the elongation A of 15.1% or more. In addition, it was confirmed that the insulator 22 can be sufficiently separated from the conductor 21 by only performing the rolling processing to have the elongation A of 87.5% or more.

### Functions and Effect of the Embodiment

As explained above, according to the method for recovering copper or copper alloy from the enameled wire 2 in the present embodiment, in the separating step, the rolling processing is performed to have the elongation A expressed in the following formula be 15.1% or more:

$$A = \{ ( A 1 - A 2 ) / A 2 \} \times 100 ,$$

where A1 is the cross-sectional area of the conductor 21 before the rolling processing and A2 is the cross-sectional area of the conductor 21 after the rolling processing.

By performing the rolling processing in such a manner that the elongation A is 15.1% or more, the insulator 22 can be separated from the conductor 21 by utilizing the difference of stretchability between the conductor 21 and the insulator 22, and the insulator 22 can be easily stripped and removed from the conductor 21. In the present embodiment, chemicals that require wastewater treatment are not used, and the environmental load is low. In addition, the conductor 21 is not oxidized, or the carbonized insulator 22 is not integrated with the conductor 21, since the heat treatment is not needed, so that it is possible to recover high-purity copper. Further, in the present embodiment, it is unnecessary to perform treatment with chemicals for which the processing costs are high, and because commonly used equipment for compression processing or rolling processing can be diverted, both equipment costs and processing costs are extremely low, enabling copper or copper alloys to be recovered at low cost.

### Modified Examples

In the above embodiment, although the slitting step is performed before the separating step, the slitting step may be performed after the separating step. In addition, although the slits 22a are made in the insulator 22 by using the roll cutters 41a, 41b in the slitting step, the present invention is not limited thereto, and a non-rotating cutter may be used, and the slit 22a may be made in the insulator 22 by using laser.

### Summary of Embodiments

Technical ideas understood from the embodiment will be described below citing the reference signs, etc. used for the embodiment. However, each reference sign described below is not intended to limit the constituent elements in the claims to the members, etc., specifically described in the embodiment.

[1] A method for recovering copper or copper alloy from enameled wire, by removing an insulator (22) from an enameled wire (2) including the insulator (22) around a conductor (21) made of copper or copper alloy, including:
a separating step of separating the insulator (22) from the conductor (21), by performing a rolling processing on the enameled wire (2); and
a removing step of removing the insulator (22) separated from the conductor (21) in the separating step,
wherein, in the separating step, the rolling processing is performed to have an elongation A expressed in a following formula be 15.1% or more:

$$A = \{ ( A 1 - A 2 ) / A 2 \} \times 100 ,$$

where A1 is a cross-sectional area of the conductor (21) before the rolling processing and A2 is a cross-sectional area of the conductor (21) after the rolling processing.

[2] The method for recovering copper or copper alloy from enameled wire, as described by [1], wherein, in the separating step, the rolling processing is performed to have the elongation A be 87.5% or more.

[3] The method for recovering copper or copper alloy from enameled wire, as described by [1], further including:
a feeding step of feeding the enameled wire (2) wound on a bobbin continuously; and
a slitting step of slitting the insulator (22) of the enameled wire (2) along a longitudinal direction continuously.

[4] The method for recovering copper or copper alloy from enameled wire, as described by [3], wherein the slitting step is performed before the separating step.

[5] The method for recovering copper or copper alloy from enameled wire, as described by [3], wherein the slitting step includes:
a first slitting step of making a slit (22a) in the insulator (22), by passing the enameled wire (2) between a first roll cutter (41a) and a first guide roll (42a); and
a second slitting step of making a slit (22a) in the insulator (22) at an opposite position to the slit (22a) formed in the first slitting step, by passing the enameled wire between a second roll cutter (41b) and a second guide (42b) after the slitting step.

[6] The method for recovering copper or copper alloy from enameled wire, as described by [1], wherein, in the removing step, the insulator (22) is removed from the conductor (21) by treatment using a wire brush or scraper, high-pressure water jet treatment, compressed air injection treatment, or blast treatment.

[7] An apparatus (1) for recovering copper or copper alloy from enameled wire, by removing an insulator (22) from an enameled wire (2) including the insulator (22) around a conductor (21) made of copper or copper alloy, comprising:
a separating device (5) that separates the insulator (22) from the conductor (21), by performing a rolling processing on the enameled wire (2); and
a removing device (6) that removes the insulator (22) separated from the conductor (21) by the separating device (5),
wherein the separating device (5) performs the rolling processing to have an elongation A expressed in a following formula be 15.1% or more:

$$A = \{ ( A 1 - A 2 ) / A 2 \} \times 100 ,$$

where A1 is a cross-sectional area of the conductor (21) before the rolling processing and A2 is a cross-sectional area of the conductor (21) after the rolling processing.

### (Note)

Although the embodiment of the invention has been described, the invention according to claims is not to be limited to the above-described embodiment. Further, please note that not all combinations of the features described in the embodiment are necessary to solve the problem of the invention. In addition, the various kinds of modifications can be implemented without departing from the gist of the invention.

### EXPLANATION OF SIGNS

1 . . . Copper or copper alloy recovering apparatus
2 . . . Enameled wire
21 . . . Conductor
22 . . . Insulator
22a . . . Slit
3 . . . Feeding device
31 . . . Bobbin
4 . . . Slitting device
41a . . . First roll cutter
41b . . . Second roll cutter
42a . . . First guide roll
42b . . . Second guide roll
5 . . . Separating device
51 . . . Rolling roll
6 . . . Removing device
7 . . . Take-up device
8 . . . Conductor collection box
9 . . . Insulator collection box

1. A method for recovering copper or copper alloy from enameled wire, by removing an insulator from an enameled wire including the insulator around a conductor made of copper or copper alloy, comprising:
a separating step of separating the insulator from the conductor, by performing a rolling processing on the enameled wire; and
a removing step of removing the insulator separated from the conductor in the separating step,
wherein, in the separating step, the rolling processing is performed to have an elongation A expressed in a following formula be 15.1% or more:
$$A = \{ ( A 1 - A 2 ) / A 2 \} \times 100 ,$$
where A1 is a cross-sectional area of the conductor before the rolling processing and A2 is a cross-sectional area of the conductor after the rolling processing.

2. The method for recovering copper or copper alloy from enameled wire, according to claim 1, wherein, in the separating step, the rolling processing is performed to have the elongation A be 87.5% or more.

3. The method for recovering copper or copper alloy from enameled wire, according to claim 1, further comprising:
a feeding step of feeding the enameled wire wound on a bobbin continuously; and
a slitting step of slitting the insulator of the enameled wire along a longitudinal direction continuously.

4. The method for recovering copper or copper alloy from enameled wire, according to claim 3, wherein the slitting step is performed before the separating step.

5. The method for recovering copper or copper alloy from enameled wire, according to claim 3, wherein the slitting step comprises:
a first slitting step of making a slit in the insulator, by passing the enameled wire between a first roll cutter and a first guide roll; and
a second slitting step of making a slit in the insulator at an opposite position to the slit formed in the first slitting step, by passing the enameled wire between a second roll cutter and a second guide roll after the slitting step.

6. The method for recovering copper or copper alloy from enameled wire, according to claim 1, wherein, in the removing step, the insulator is removed from the conductor by treatment using a wire brush or scraper, high-pressure water jet treatment, compressed air injection treatment, or blast treatment.

7. An apparatus for recovering copper or copper alloy from enameled wire, by removing an insulator from an enameled wire including the insulator around a conductor made of copper or copper alloy, comprising:
a separating device that separates the insulator from the conductor, by performing a rolling processing on the enameled wire; and
a removing device that removes the insulator separated from the conductor by the separating device,
wherein the separating device performs the rolling processing to have an elongation A expressed in a following formula be 15.1% or more:
$$A = \{ ( A 1 - A 2 ) / A 2 \} \times 100 ,$$
where A1 is a cross-sectional area of the conductor before the rolling processing and A2 is a cross-sectional area of the conductor after the rolling processing.
